(19) United States
(12) Patent Application Publication
(10) Pub. No.: US 2005/0248863 A1
(43) Pub. Date: Nov. 10, 2005

(54) Outside mirror apparatus for vehicle

(75) Inventor: Joichi Kawanishi, Isehara-shi (JP)

Correspondence Address: FOLEY AND LARDNER;SUITE 500, 3000 K STREET NW, WASHINGTON, DC, 20007, US

(73) Assignee: ICHIKOH INDUSTRIES, LTD.

(21) Appl. No.: 11/122,230

(22) Filed: May 5, 2005

(30) Foreign Application Priority Data
May 10, 2004 (JP) 2004-140082

(51) Int. Cl. F16M 13/00; G02B 7/182

(52) U.S. Cl. 359/877; 359/872

(57) ABSTRACT

An outside mirror apparatus for a vehicle includes a mirror base; a mirror housing that is fixed to the mirror base to cover the stay portion; an electric part that is fixed to at least one of the mirror housing and the stay portion; a harness including a bundle of wires that connects the electric part and a power source; and a hook portion that is arranged at an edge of the base portion, at which the harness is hooked so that the harness is guided to the surface of the base portion. The mirror base includes a base portion of which a surface is fixed to a vehicle body, and a stay portion that is provided integrally with the base portion on a side opposite to the surface of the base portion.

### CROSS-REFERENCE TO RELATED APPLICATIONS

The present document incorporates by reference the entire contents of Japanese priority document, 2004-140082 filed in Japan on May 10, 2004.

### BACKGROUND OF THE INVENTION

1. Field of the Invention

The present invention relates to an outside mirror apparatus for a vehicle, and more particularly to an outside mirror apparatus that includes electric parts such as an illumination device, an image pickup device, and a power unit.

2. Description of the Related Art

A technology for an outside mirror apparatus for a vehicle is disclosed in, for example, Japanese Patent Application Laid-Open No. 2001-55089. In the outside mirror apparatus, a through hole is arranged in a supporting member of a door mirror stay. A power cord is inserted into the through hole, and through the power cord, an internal mechanism in a door mirror visor is supplied with power.

Such the outside door mirror apparatus, however, has a problem in workability because of such a structure that the cord is necessary to be inserted through the through hole.

### SUMMARY OF THE INVENTION

It is an object of the present invention to solve at least the above problems in the conventional technology.

An outside mirror apparatus according to one aspect of the present invention is for a vehicle and includes a mirror base; a mirror housing that is fixed to the mirror base to cover the stay portion; an electric part that is fixed to at least one of the mirror housing and the stay portion; a harness including a bundle of wires that connects the electric part and a power source; and a hook portion that is arranged at an edge of the base portion, at which the harness is hooked so that the harness is guided to the surface of the base portion. The mirror base includes a base portion of which a surface is fixed to a vehicle body, and a stay portion that is provided integrally with the base portion on a side opposite to the surface of the base portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an outside mirror apparatus according to an embodiment of the invention viewed from a side on which a mirror is attached;

FIG. 2 is a cutaway view of the door mirror apparatus viewed from an opposite side to the side shown in FIG. 1;

FIG. 3 is a cross-section of the outside mirror apparatus taken along a line III-III shown in FIG. 1;

FIG. 4 is a perspective view of the outside mirror apparatus viewed in a direction indicated by an arrow IV shown in FIG. 1;

FIG. 5 is a cross-section of the outside mirror apparatus taken along a line V-V shown in FIG. 4;

FIG. 6 is a perspective view of a mirror base to which a harness half-assembled is installed;

FIG. 7 is an exploded view of the mirror base and the harness before installation;

FIG. 8 is a perspective view of the mirror base shown in FIG. 7 viewed in a direction indicated by an arrow VIII shown in FIG. 7; and

FIG. 9 is a perspective view of the mirror base shown in FIG. 6 viewed in a direction indicated by an arrow IX shown in FIG. 6.

### DETAILED DESCRIPTION OF THE PREFERRED EMBODIMENTS

Exemplary embodiments according to the present invention will be explained in detail below with reference to the accompanying drawings. In the drawings, a reference character “F” represents a front side of a vehicle, and a reference character “B” represents a back side of a vehicle. A reference character “U” represents an upward side of a vehicle, and a reference character “D” represents a downward side of a vehicle. A reference character “L” represents a left side, which is a side of a vehicle on left when the front side is viewed from the back side, and a reference character “R” represents a right side, which is a side of a vehicle on right when the front side is viewed from the back side. A “front surface” in the outside mirror apparatus according to the present invention is a surface on the back side B. On the other hand, a “rear surface” in the outside mirror apparatus is a surface on the front side F.

An outside mirror apparatus for a vehicle according to an embodiment of the present invention is explained using a door mirror for an automobile as an example. The door mirror is mounted on each of doors (a vehicle body) arranged on the left side L and the right side R. A door mirror 1 shown in the figures is a door mirror that is mounted on the door on the left side L. A door mirror mounted on a door on the right side R is approximately bilaterally-symmetrical with the door mirror 1.

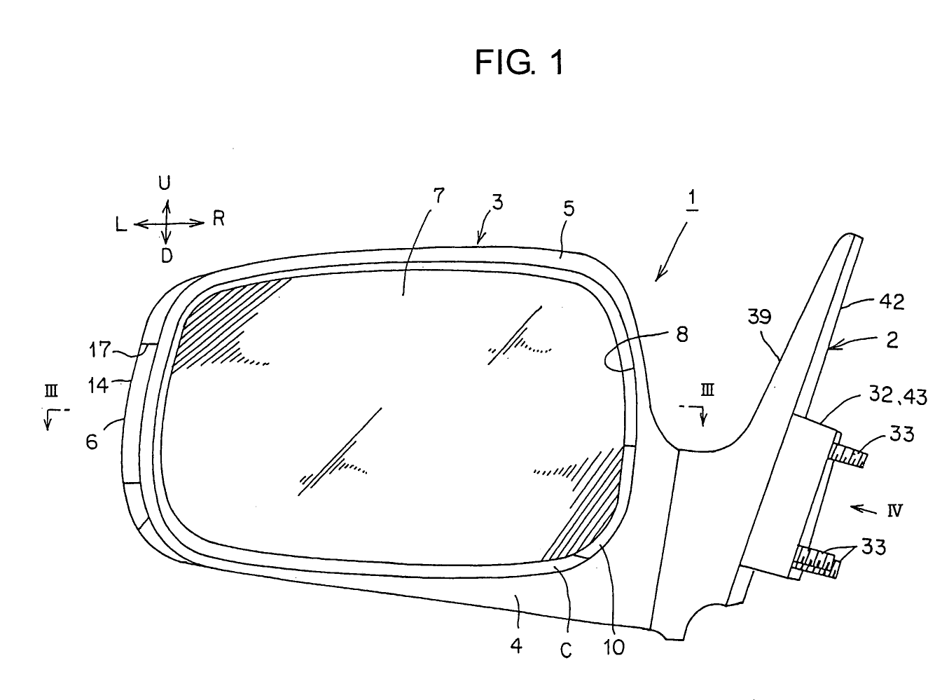

As shown in FIGS. 1 to 5, the door mirror 1 includes a mirror base 2 fixed to the door and a mirror assembly 3 that is mounted on the mirror base 2. As shown in FIGS. 1 to 4, the mirror assembly 3 includes a mirror housing 4, a garnish 5, a side turn-signal lamp 6, and a mirror unit 7.

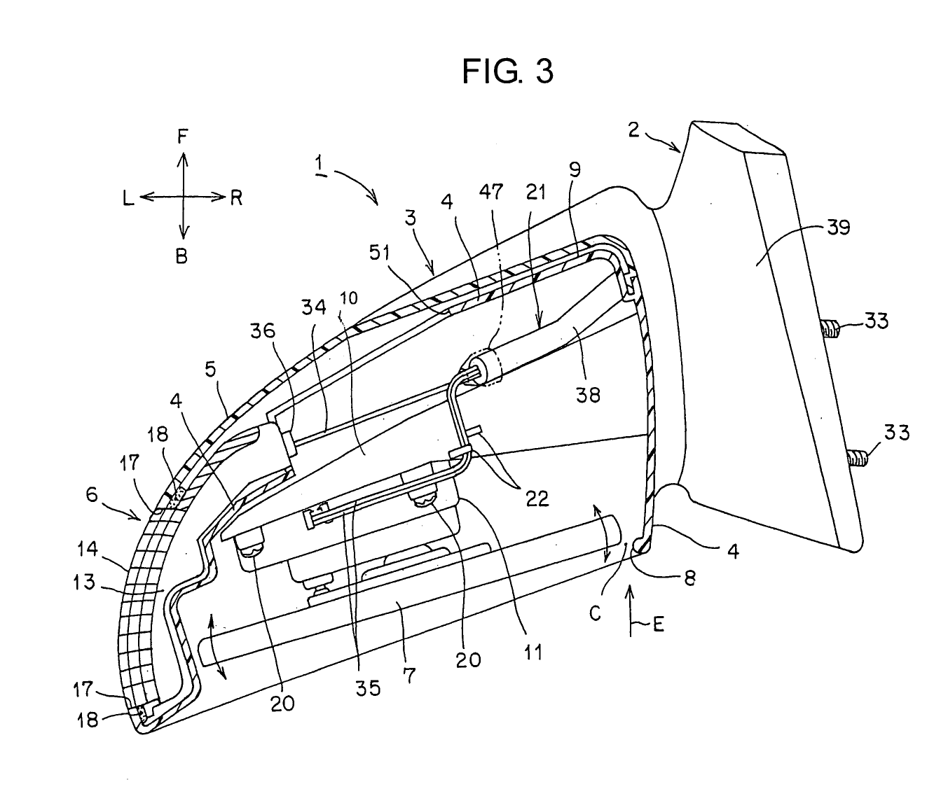

As shown in FIG. 3, the mirror housing 4 includes an opening 8 on the back side B. Other portions of the mirror housing 4 including a portion on the front side F are closed in such a manner that the mirror housing 4 has a hollow structure to form a closed portion 9. A window 51 is provided at an approximately central portion of the closed portion 9. The mirror housing 4 is fixed to the mirror base 2 by a screw (not shown). The mirror unit 7 is disposed at the opening 8 of the mirror housing 4. As shown in FIG. 3, the mirror unit 7 is tiltably mounted on a stay portion 10 of the mirror base 2. The mirror unit 7 can be tilted in a horizontal direction about a substantially vertical axis and in a vertical direction about a substantially horizontal axis through a power unit 11. The mirror unit 7 has a reflecting surface that reflects a backward view of the automobile.

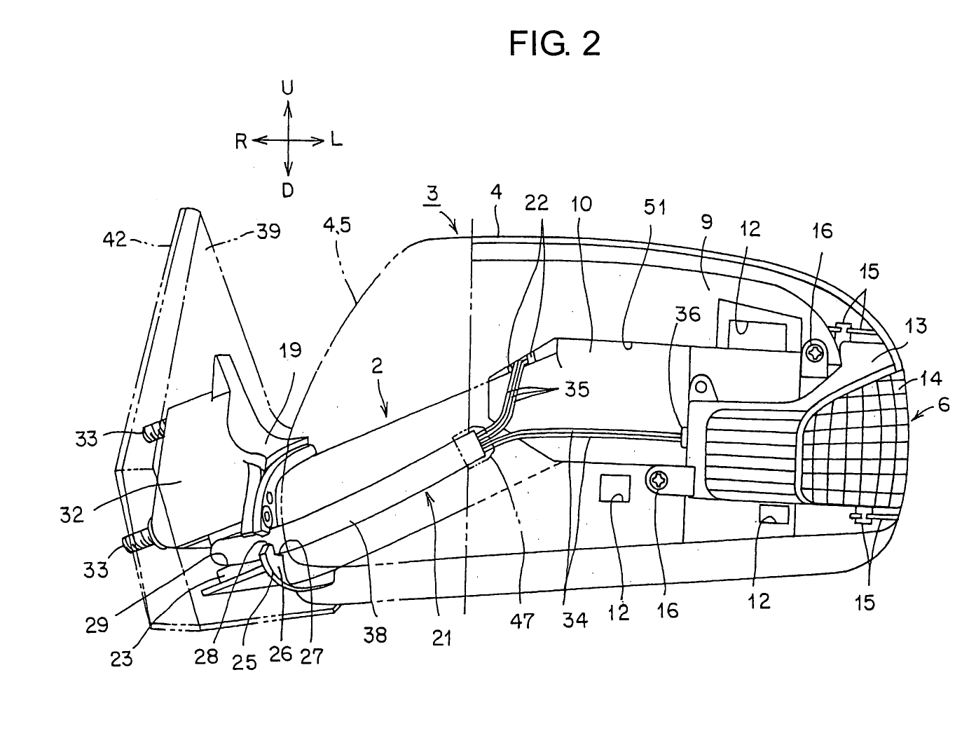

Portions of the closed portion 9 on the front side F, the upward side U, and the left side L are covered with the garnish 5. The garnish 5 includes split portions positioned on the front side F, the upper side U, and the left side L of the mirror housing 4. The garnish 5 has a form of a cover (skullcap, or design cover). Several engagement holes 12 with, for example, a rectangle shape are provided in the closed portion 9. Three units of the engagement holes 12 are shown in FIG. 2. Engaging claws (not shown) are provided on an inner surface of the garnish 5. Each of the engaging claws corresponds to each of the engagement holes 12. The engaging claw is engaged with an edge of the engagement hole 12 so that the garnish 5 is fixed to the mirror housing 4. Thus, the mirror housing 4 and the garnish 5 is integrated.

As shown in FIGS. 2 and 3, the side turn-signal lamp 6 includes a lamp housing 13 that forms a lamp chamber (not shown), a lamp lens 14, and at least one of a light emitting diode (LED) (not shown) as a light source arranged in the lamp chamber. The side turn-signal lamp 6 is fixed to a portion of the closed portion 9 on the left side L by a temporary fixing unit 15 and a main fixing unit 16. The temporary fixing unit 15 includes, for example, a plate portion with a V-shaped groove and an H-shaped guide rail to be engaged with the V-shaped groove. On the other hand, the main fixing unit 16 includes a fixing plate portion and a screw. The lamp lens 14 has a projecting portion. The projecting portion is exposed to the outside through a notch 17 having a substantially trapezoidal shape provided on the garnish 5 on the left side L of. A packing 18 is interposed between the garnish 5 and the lamp lens 14. The side turn-signal lamp 6 illuminates in amber (or yellow) color to a predetermined light distribution zone in a blinking manner to notify a turning direction or the like to other drivers or walkers.

The mirror base 2 includes a base portion 19 at which the mirror base is fixed to the door and the stay portion 10 provided integrally with the base portion 19. As shown in FIGS. 2, 3, 6, and 7, the stay portion 10 is open on the back side B. Other portions of the stay portion 10 are closed, thus forming a hollow structure in the stay portion 10. Ribs (not shown) for reinforcement are integrally provided inside the stay portion 10. The power unit 11 is fixed to the stay portion 10 on a front surface side by screws 20. The power unit 11 is arranged at a portion of the stay portion 10 at an end opposite to an end at which the base portion 19 is arranged. The mirror unit 7 is attached to the power unit 11. Thus, the mirror unit 7 is tiltably arranged in the opening 8 of the mirror housing 4. The stay portion 10 includes a holding portion 22 for holding a harness 21. The holding portion 22 is integrally formed on a portion on the upward side U at about a midpoint position of the stay portion 10. The holding portion 22 includes two projections having a reversed L shape arranged opposing to each other.

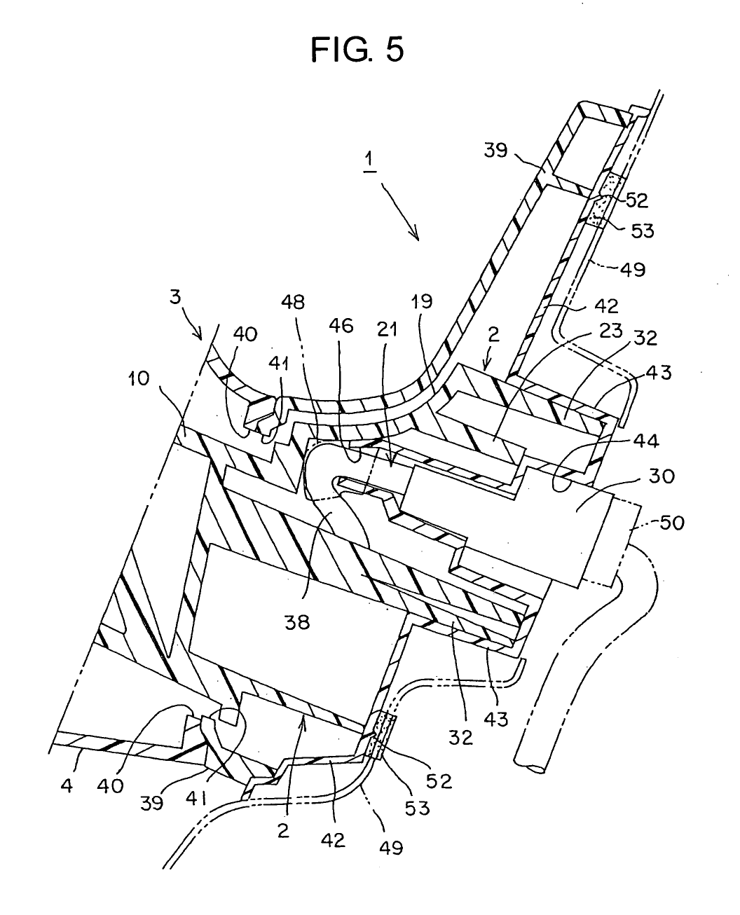

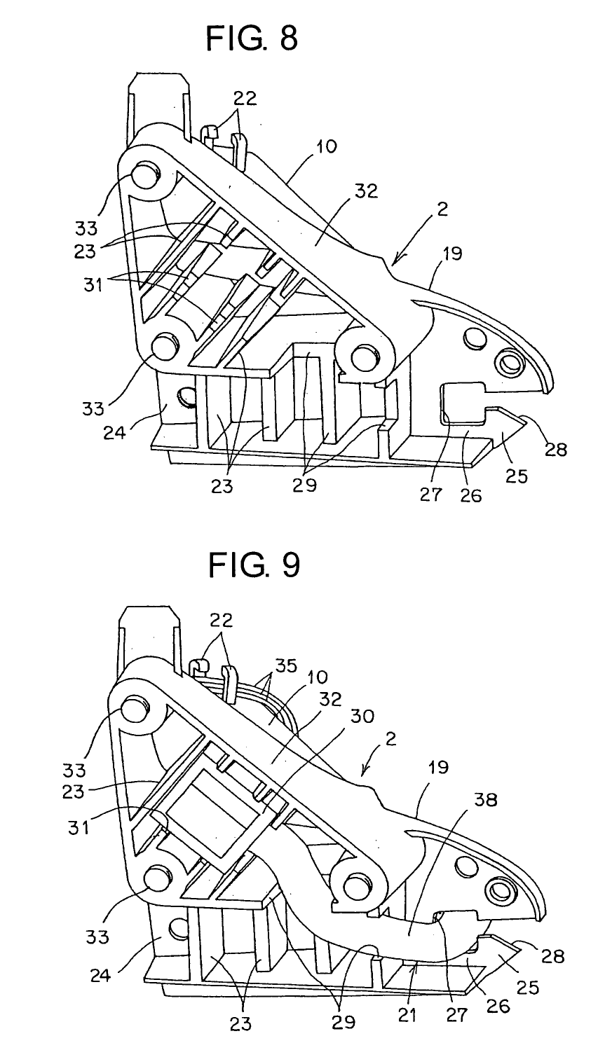

As shown in FIGS. 5, 8, and 9, the base portion 19 is open on the right side R. Other portions are closed, thus forming a hollow structure in the base portion 19. Ribs 23 for reinforcement are integrally provided inside the base portion 19. Edge portions 24 and 25 are provided on the base portion 19. The edge portions 24 and 25 are arranged on the front surface side and a rear surface side in a boundary region between the base portion 19 and the stay portion 10 respectively. A hook portion 26 at which the harness 21 is caught is provided on the edge portion 25 on the rear surface side. The hook portion 26 includes a through-hole 27 in a substantially square shape and a groove 28 communicating with the through-hole 27 that are formed on the edge portion 25. The groove 28 is formed in such a manner that a width of the groove 28 gradually becomes narrower toward the through-hole 27, so that the harness 21 is easily caught at the hook portion 26 and hardly comes off therefrom.

The rib 23 of the base portion 19 is provided with a concave portion 29 in which the harness 21 is wired and a concave portion 31 in which a connector 30 on a mirror side is arranged. The base portion 19 is integrally provided with a surrounding wall 32 having a generally triangular shape, surrounding the concave portion 31 (the concave portion for connector arrangement on the mirror side). A bolt 33 is fixed at each of three corners of the generally triangular shape.

As shown in FIGS. 2 to 7 and FIG. 9, the harness 21 includes two lamp harnesses 34 through which power is supplied to electric parts in the side turn-signal lamp 6 and three power unit harness 35 through which power is supplied to electric parts in the power unit 11. One end of the lamp harness 34 is connected to a lamp connector 36 connected to the side turn-signal lamp 6. One end of the power unit harness 35 is connected to a power unit connector 37 connected to the power unit 11. On the other hand, each of another end of the lamp harness 34 and another end of the power unit harness 35 is connected to a connector 30 on the mirror side. The other end of the harness 21 is covered with a tube 38. The tube 38 may be arranged so as to cover an entire length of the harness 21 or a portion thereof. The tube 38 may not be provided.

As shown in FIGS. 1 to 3, and FIG. 5, the door mirror 1 includes a base cover 39. The mirror housing 4 and the base cover 39 include insertion holes 40 and 41 in which the stay portion 10 is inserted. The stay portion 10 is inserted in the mirror housing 4 via the insertion holes 40 and 41. Thus, the stay portion 10 is covered with the mirror housing 4. An edge portion of the insertion hole 41 of the base cover 39 is sandwiched and fixed between an edge portion of the insertion hole 40 of the mirror housing 4 and the edge portions 24 and 25 of the mirror base 2 by a screw (not shown).

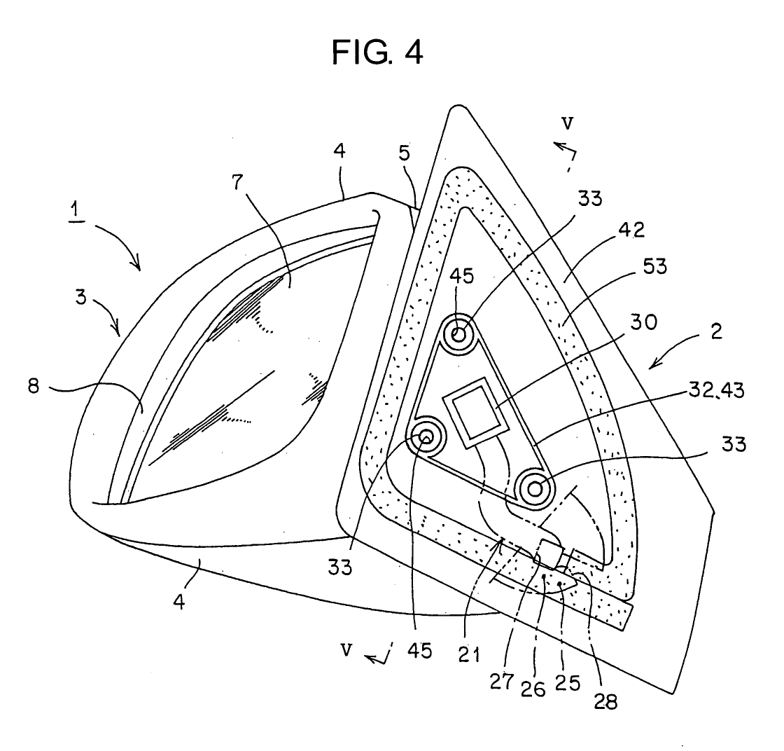

As shown in FIGS. 4 and 5, a gasket 42 is arranged on a surface of the base portion 19 on which the base portion 19 is fixed to the door and on a surface of the base cover 39 on which the base cover 39 is fixed to the base cover 39 is fixed to the door. The gasket 42 includes a first concave portion 43 to be fitted with the surrounding wall 32. A second concave portion 44 to be fitted with the connector 30 is provided on a bottom portion of the first concave portion 43. Through a through-hole 45 for inserting the bolt 33 is provided at each of three corners of the first concave portion 43. On the other hand, a through hole 46 for inserting the harness 21 is provided on a bottom portion of the second concave portion 44. An entire circumference of an edge portion of the gasket 42 on a surface on which the gasket 42 is fixed to the vehicle body is integrally provided with a rib 52 with a small triangular section, and a water-proofing tape 53 (synthetic rubber foam) is fixedly adhered to the gasket 42 along the rib 52.

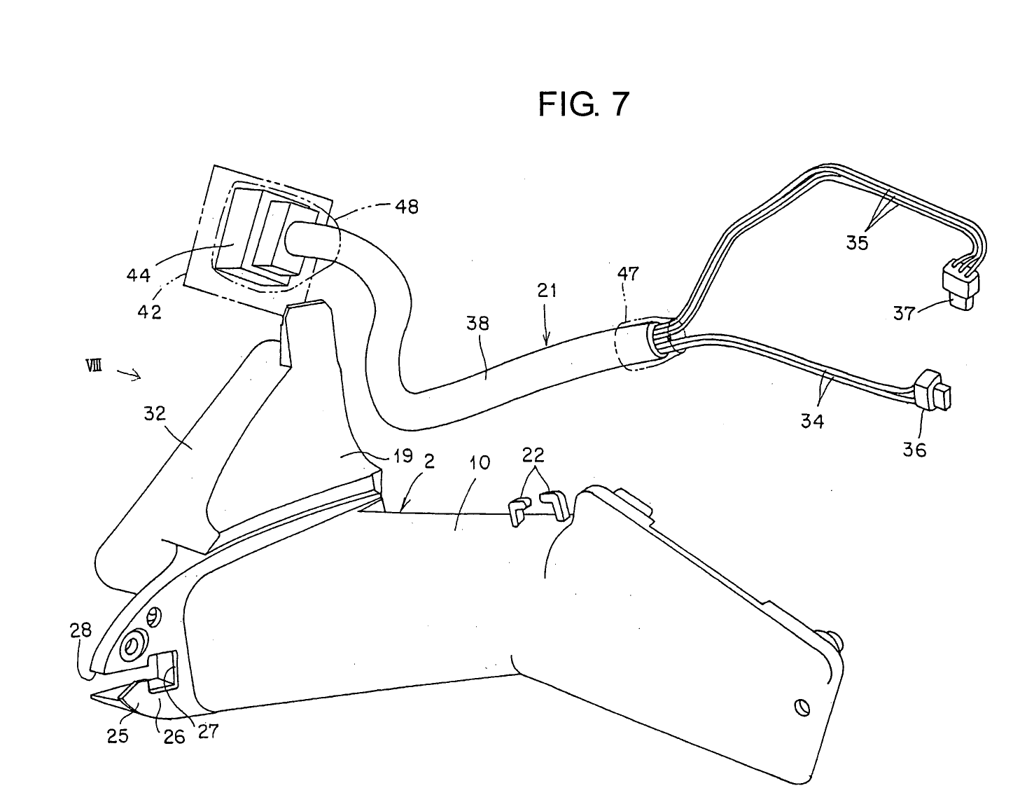

As shown in FIG. 7, the harnesses 21, 34, 35, the connectors 30, 36, 37, the tube 38, and the gasket 42 are assembled into a single unit. Specifically, one end of the lamp harness 34 is connected to the lamp connector 36. One end of the power unit harness 35 is connected to the power unit connector 37. On the other hand, the other end of the lamp harness 34 and the other end of the power unit harness 35 are connected to the connector 30. The other end of the harness 21 including the lamp harness 34 and the power unit harness 35 is covered with the tube 38. The harness 21 and the one end portion of the tube 38 are wounded with a tape 47 (shown with a double-dotted chain line in FIGS. 2, 3, 6, and 7). Furthermore, the connector 30 is fitted into the second concave portion 44 of the base cover 39. The harness 21 is inserted into the through hole 46 of the base cover 39. The second concave portion 44 of the gasket 42 and the other end of the tube 38 for the harness 21 are wounded with a tape 48 (shown with a double-dotted chain line in FIGS. 5 and 7).

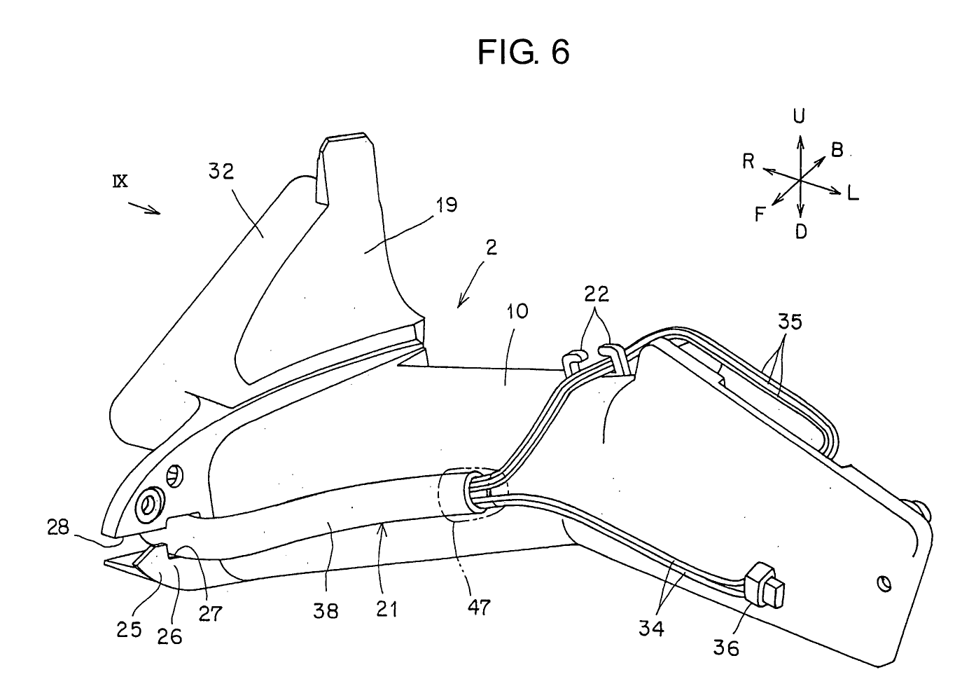

As shown in FIG. 7, the harnesses 21, 34, 35, the connectors 30, 36, 37, the tube 38, and the gasket 42 are half-assembled. As shown in FIG. 6, the harness 21 half-assembled is positioned in the through-hole 27 via the groove 28 of the mirror base 2 and is caught at the hook portion 26. The harness 21 is wired on the rear surface side of the stay portion 10. The power unit harness 35 is held at the holding portion 22 of the stay portion 10.

The stay portion 10 with the harness 21 is inserted into the insertion hole 41 of the base cover 39 and the insertion hole 40 of the mirror housing 4 to be inserted into the mirror housing 4. The mirror base 2, the mirror housing 4, and the base cover 39 are fixed together by a screw. The harness 21 is wired in the concave portion 29 of the mirror base 2, and the connector 30 is disposed in the concave portion 31 of the mirror base 2. In this state, the first concave portion 43 of the gasket 42 half-assembled is fitted on the surrounding wall 32 of the mirror base 2, and the bolts 33 are inserted into the through-holes 45 of the gasket 42. The gasket 42 is arranged on the surfaces on which the base portion 19 and the base cover 39 are fixed to the door.

On the other hand, the power unit 11 is fixed to the stay portion 10 inserted into the mirror housing 4 by the screws 20. The power unit 11 is connected with the power unit connector 37. The power unit 11 is attached with the mirror unit 7. The side turn-signal lamp 6 is fixed to the mirror housing 4 fixed to the mirror base 2 by the temporary fixing unit 15 and the main fixing unit 16. The lamp harness 34 wired inside the mirror housing 4 is wired on the rear surface side of the mirror housing 4 through the window 51 of the mirror housing 4. The lamp connector 36 of the lamp harness 34 is connected to the side turn-signal lamp 6. Next, the mirror housing 4 is attached with the garnish 5. Thus, the door mirror 1 is assembled. A process of attaching the power unit 11 and the mirror unit 7 to the stay portion 10 and a process of fixing the side turn-signal lamp 6 to the mirror housing 4 may be performed in a different order of steps form that explained above.

The door mirror 1 assembled is fixed to a door panel 49 (vehicle body) (shown with a double-dotted chain line in FIG. 5) of the automobile. That is, the door mirror 1 is fixed to the door by inserting the bolts 33 into the through-holes (not shown) arrange on the door panel 49 and by screwing nuts (not shown) on the bolts 33. The connector 30 of the door mirror 1 on the mirror side is connected to a connector 50 (see a double-dotted chain line in FIG. 5) of a vehicle body side. Thereby, the side turn-signal lamp 6 and the power unit 11, which are electric parts, are connected to a power source (a battery) of the vehicle via the harness 21. Thus, the electric parts are supplied with power.

Since the door mirror 1 is provided with the hook portion 26 at the edge portion 25 of the base portion 19, the harness 21 can be caught at the hook portion 26. Thus, the harness 21 can be arranged in the door mirror 1 from the side turn-signal lamp 6 and the power unit 11 to the vehicle body through the base portion 19. Therefore, the door mirror 1 has such an advantage that the handling work is simple compared to that in the conventional outside mirror apparatus in which a cord is necessary to be passed through a through-hole in a supporting portion of a door mirror stay. In the door mirror 1, the harness 21 connects the side turn-signal lamp 6 and the power unit 11 to and the power source (battery) via the connectors 30, 36, and 37, so that power is supplied to the side turn-signal lamp 6 and the power unit 11.

In the door mirror 1, the mirror unit 7 is disposed at the opening 8 on the front surface side of the mirror housing 4, the mirror unit 7 is arranged on the front surface side of the stay portion 10 via the power unit 11, the hook portion 26 is provided at the edge portion 25 of the base portion 19 on the rear surface side, and the harness 21 is wired on the rear surface side of the stay portion 10 and is caught at the hook portion 26. On the other hand, as shown in FIG. 3, a clearance C is provided between an edge of the opening 8 and an edge of the mirror unit 7 such that the mirror unit 7 can be tilted without being blocked. Even when an interior of the mirror housing 4 is viewed from the front surface side in a direction indicated by an arrow E shown in FIG. 2, the harness 21 is behind the stay portion 10, thereby obtaining a good appearance.

In the door mirror 1, the harness 21 is caught at the hook portion 26 at the edge portion 25 of the base portion 19, and arranged from the side turn-signal lamp 6 and the power unit 11 to the vehicle body via the base portion 19. Thus, in the door mirror 1 the harnesses 21, 34, 35, the connectors 30, 36, 37, the tube 38, and the gasket 42 are half-assembled. As a result, assembility of the door mirror 1 can be improved and parts management for the door mirror 1 becomes simple. In addition, in an assembly line for the door mirror 1, the number of processes can be reduced because an assembly work for the harnesses 21, 34, 35, the connectors 30, 36, 37, the tube 38, and the gasket 42 is unnecessary.

While in the embodiment described above, a case in which the door mirror is the outside mirror apparatus has been explained, the present invention is not limited to this case and is possible to be applied to another outside mirror apparatus for an automobile, such as a fender mirror and a truck mirror.

Moreover, while in the embodiment, a case in which the side turn-signal lamp 6 and the power unit 11 are the electric parts have been explained, the present invention is not limited to this case and is possible to be applied to another type of the electronic part, such as an illumination device, an image pickup device, for example, a charge-coupled device (CCD) camera, and a defogging heater for the mirror unit 7.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An outside mirror apparatus for a vehicle, comprising:
a mirror base including
a base portion of which a surface is fixed to a vehicle body; and
a stay portion that is provided integrally with the base portion on a side opposite to the surface of the base portion;
a mirror housing that is fixed to the mirror base to cover the stay portion;
an electric part that is fixed to at least one of the mirror housing and the stay portion;
a harness including a bundle of wires that connects the electric part and a power source; and
a hook portion that is arranged at an edge of the base portion, at which the harness is hooked so that the harness is guided to the surface of the base portion.

2. The outside mirror apparatus according to claim 1, further comprising a mirror unit, wherein
the mirror housing includes an opening for disposing the mirror unit,
the mirror unit is mounted on the stay portion,
the hook portion and the harness are arranged on the base portion on a rear side of the stay portion opposite to a side on which the mirror unit is arranged.

3. The outside mirror apparatus according to claim 1, wherein
the harness includes
a first connector on a first end of the harness for connecting the harness to the electric part; and
a second connector on a second end of the harness for connecting the harness to the power source,
the base portion includes a gasket for tightening the base portion to the vehicle body, and
the harness, the first connector, the second connector, and the gasket are assembled into a single unit as a sub-assembly.
